(19) United States
(12) Patent Application Publication
(10) Pub. No.: US 2020/0253022 A1
(43) Pub. Date: Aug. 6, 2020

(54) OPTICAL WRITING DEVICE, IMAGE FORMATION APPARATUS, AND COMPUTER-IMPLEMENTED METHOD

(71) Applicant: Konica Minolta, Inc., Tokyo (JP)

(72) Inventors: Masayuki IIJIMA, Okazaki-shi (JP); Takaki UEMURA, Seto-shi (JP); Yoshikazu WATANABE, Toyohashi-shi (JP); Sotaro YOKOTA, Toyohashi-shi (JP)

(21) Appl. No.: 16/774,530

(22) Filed: Jan. 28, 2020

(30) Foreign Application Priority Data
Feb. 5, 2019 (JP) 2019-018977

(51) Int. Cl. H05B 47/105; G03G 15/043

(52) U.S. Cl. CPC H05B 47/105; G03G 15/043

(57) ABSTRACT

An optical writing device includes a lens, a plurality of light emitting elements that form one pixel on a photoreceptor through the lens, and a control circuit that controls a light emitting state of each of the plurality of light emitting elements. The control circuit controls the light emitting state of each of the plurality of light emitting elements in accordance with an ambient temperature of the plurality of light emitting elements.

The entire disclosure of Japanese Patent Application No. 2019-018977, filed on Feb. 5, 2019, is incorporated herein by reference in its entirety.

### BACKGROUND

### Technological Field

The present disclosure relates to an optical writing device utilized for an image formation apparatus, and in particular to an optical writing device that forms one pixel utilizing a plurality of light emitting elements, and an image formation apparatus including such an optical writing device.

### Description of the Related Art

A variety of techniques for forming a one-pixel image using a plurality of light emitting elements in a conventional image formation apparatus such as a multi-functional peripheral (MFT) have been proposed. For example, Japanese Laid-Open Patent Publication No. H11-147326 discloses an image formation apparatus including an optical writing device having a plurality of light emission spots arranged to be inclined in a sub scanning direction.

### SUMMARY

In recent years, an image formation apparatus is utilized in various environments (temperature, humidity, and the like). Under such circumstances, there is required a technique for keeping the quality of images formed by the image formation apparatus constant despite a change in environment where the image formation apparatus is utilized.

To achieve at least one of the abovementioned objects, according to an aspect of the present invention, an optical writing device reflecting one aspect of the present invention comprises a lens, a plurality of light emitting elements that form one pixel on a photoreceptor through the lens, and a control circuit that controls a light emitting state of each of the plurality of light emitting elements in accordance with an ambient temperature of the plurality of light emitting elements.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a view showing a configuration of an image formation apparatus in accordance with the present embodiment.

FIG. 2 is a view schematically showing configurations of an optical writing device 100 and a light emitting substrate 200.

FIG. 3 is a view schematically showing a configuration of a TFT circuit 214.

FIG. 4 is a view for illustrating a circuit configuration of TFT circuit 214.

FIG. 5 is a view showing a configuration of a driver integrated circuit (IC) 212.

FIG. 6 is a view showing a configuration of a light emitting element matrix 320.

FIG. 7 is a view for illustrating arrangement of light emitting elements 600 in each light emitting element matrix 320 of TFT circuit 214.

FIG. 8 is a view showing a wiring pattern of light emitting element matrix 320.

FIG. 9 is a view for illustrating the relation between the arrangement of the light emitting elements in light emitting element matrix 320 and an image formed utilizing light emitting element matrix 320.

FIG. 10 is a view for illustrating a configuration of a microlens array 201.

FIG. 11 is a view showing a hardware configuration of an image formation apparatus 1.

FIG. 12 is a view schematically showing an example of the relation between an environmental temperature of the light emitting elements and the shape of a beam formed on a photoreceptor drum.

FIG. 13 is a view showing specific examples of a manner of ON/OFF of each of 100 light emitting elements 600 constituting light emitting element matrix 320.

FIG. 14 is a view for illustrating an overview of control in accordance with the present embodiment.

FIG. 15 is a view showing an example of data utilized to set optical writing device 100 to each of three states (state ST-1 to state ST-3) shown in FIG. 13.

FIG. 16 is a flowchart of processing for controlling a lighted state of light emitting elements 600 of light emitting element matrix 320 in accordance with an ambient temperature.

FIG. 17 is a view schematically showing an example of a database for adjustment generated during manufacturing.

FIG. 18 is a view schematically showing a configuration of image formation apparatus 1 in which a plurality of light emitting element matrices 320 are respectively arranged at mutually different distances from the surface of a photoreceptor drum 101.

### DETAILED DESCRIPTION OF EMBODIMENTS

Hereinafter, one or more embodiments of the present invention will be described with reference to the drawings. However, the scope of the invention is not limited to the disclosed embodiments.

Hereinafter, one embodiment of an optical writing device and an image formation apparatus including the optical writing device will be described with reference to the drawings. In the description below, identical parts and components will be designated by the same reference numerals. Since their names and functions are also the same, the description thereof will not be repeated.

[1] Configuration of Image Formation Apparatus

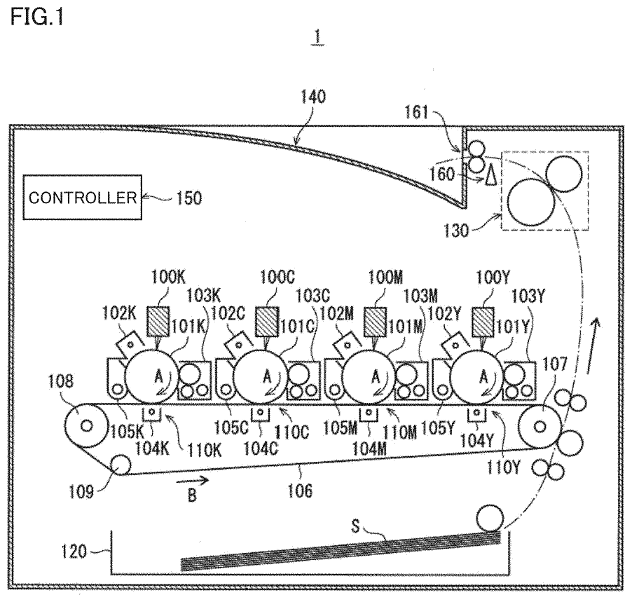

FIG. 1 is a view showing a configuration of an image formation apparatus in accordance with the present embodiment. The image formation apparatus in accordance with the present embodiment forms an electrostatic latent image of each pixel using a light emitting element matrix having a plurality of light emitting elements arranged in the shape of a grid. The configuration thereof will be described below.

As shown in FIG. 1, an image formation apparatus 1 is a so-called tandem-type color printer, and includes image formation stations 110Y, 110M, 110C, and 110K that form toner images in respective colors of yellow (Y), magenta (M), cyan (C), and black (K). Image formation stations 110Y, 110M, 110C, and 110K have photoreceptor drums 101Y, 101M, 101C, and 101K that rotate in a direction indicated by arrows A.

Charging devices 102Y, 102M, 102C, and 102K, optical writing devices 100Y, 100M, 100C, and 100K, developing devices 103Y, 103M, 103C, and 103K, primary transfer chargers 104Y, 104M, 104C, and 104K, and cleaning devices 105Y, 105M, 105C, and 105K are placed in order around photoreceptor drums 101Y, 101M, 101C, and 101K along outer circumferential surfaces thereof.

Charging devices 102Y, 102M, 102C, and 102K uniformly charge the outer circumferential surfaces of photoreceptor drums 101Y, 101M, 101C, and 101K. Optical writing devices 100Y, 100M, 100C, and 100K expose light to the outer circumferential surfaces of photoreceptor drums 101Y, 101M, 101C, and 101K, and form electrostatic latent images.

Developing devices 103Y, 103M, 103C, and 103K supply toners in the respective colors of YMCK and develop the electrostatic latent images to form toner images in the respective colors of YMCK. Primary transfer chargers 104Y, 104M, 104C, and 104K electrostatically transfer the toner images carried on photoreceptor drums 101Y, 101M, 101C, and 101K to an intermediate transfer belt 106 (primary transfer).

Cleaning devices 105Y, 105M, 105C, and 105K remove charges remaining on the outer circumferential surfaces of photoreceptor drums 101Y, 101M, 101C, and 101K after the primary transfer, and also remove remaining toners. It should be noted that, when a configuration common to image formation stations 110Y, 110M, 110C, and 110K is described below, characters YMCK will be omitted.

Intermediate transfer belt 106 is an endless belt, is stretched between a secondary transfer roller pair 107 and driven rollers 108, 109, and rotationally travels in a direction indicated by an arrow B. By performing the primary transfer in accordance with this rotational traveling, the toner images in the respective colors of YMCK are mutually superimposed to form a color toner image. Intermediate transfer belt 106 rotationally travels with the color toner image being carried thereon, and conveys the color toner image to a secondary transfer nip of secondary transfer roller pair 107.

Two rollers constituting secondary transfer roller pair 107 form the secondary transfer nip by being pressed into contact with each other. A secondary transfer voltage is applied between these rollers. When a recording sheet S is fed from a paper feed tray 120 in accordance with the timing of conveyance of the color toner image by intermediate transfer belt 106, the color toner image is electrostatically transferred onto recording sheet S at secondary transfer nip (secondary transfer).

Recording sheet S is conveyed to a fixing device 130 with the color toner image being carried thereon. After the color toner image is thermally fixed thereon, recording sheet S is ejected onto a paper ejection tray 140. An inline sensor 160 is a charge coupled device (CCD) camera, and is placed on a path for conveying recording sheet S from fixing device 130 to an ejection port 161. Inline sensor 160 captures the toner image fixed on recording sheet S to generate image data.

Image formation apparatus 1 further includes a controller 150. Controller 150 is an example of a control device. When controller 150 receives a print job from an external apparatus such as a personal computer (PC), controller 150 controls operation of image formation apparatus 1 to perform image formation. During image formation, uneven density is suppressed by referring to the image data generated by inline sensor 160.

[2] Configuration of Optical Writing Device

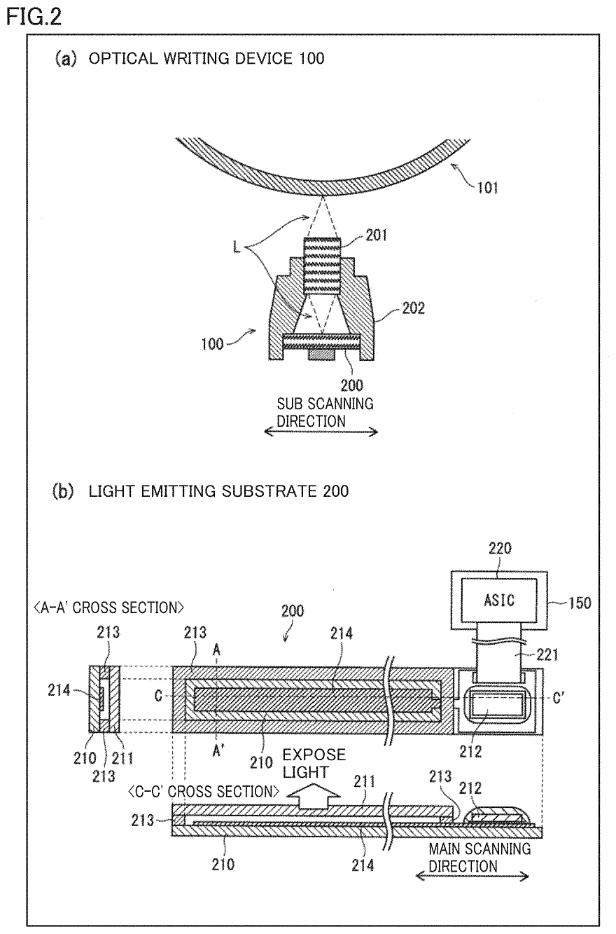

FIG. 2 is a view schematically showing configurations of optical writing device 100 and a light emitting substrate 200. First, the configuration of optical writing device 100 will be described with reference to FIG. 2(a).

As shown in FIG. 2(a), optical writing device 100 has a configuration of holding light emitting substrate 200 and a microlens array 201 using a holding member 202, and condenses emitted light L from light emitting substrate 200 on the outer circumferential surface of photoreceptor drum 101 by microlens array 201. It should be noted that a cable or the like for connecting optical writing device 100 and another device of image formation apparatus 1 is not shown.

FIG. 2(b) is a view schematically showing the configuration of light emitting substrate 200 of optical writing device 100. As shown in FIG. 2(b), light emitting substrate 200 includes a glass substrate 210, a sealing plate 211, a driver integrated circuit (IC) 212, and the like. Driver IC 212 is an example of a control circuit. On glass substrate 210, a thin film transistor (TFT) circuit 214 is formed. On TFT circuit 214, 15,000 light emitting element matrices (not shown) are staggered to correspond to microlenses, at a pitch of 21.2 μm (1200 dpi) along a main scanning direction. The above number (15,000) of the light emitting element matrices arranged to correspond to the microlenses is merely an example, and the number can be changed as appropriate in accordance with the performance of the image formation apparatus and the like.

A substrate surface of glass substrate 210 on which the light emitting element matrices are placed serves as a sealed region, and sealing plate 211 is attached thereto with a spacer frame body 213 being sandwiched therebetween. Thereby, the sealed region is sealed with dry nitrogen and the like being enclosed therein to avoid contact with outside air. For moisture absorption, a moisture absorption agent may also be enclosed in the sealed region. Sealing plate 211 may be sealing glass, for example, or may be made of a material other than glass.

Driver IC 212 is mounted outside the sealed region of glass substrate 210. An application specific integrated circuit (ASIC) 220 of controller 150 inputs a digital luminance signal into driver IC 212 via a flexible wire 221. Driver IC 212 converts the digital luminance signal into an analog luminance signal (hereinafter simply referred to as a “luminance signal”), and inputs the luminance signal into a drive circuit for each light emitting element matrix. The drive circuit generates a drive current for the light emitting element matrix in accordance with the luminance signal. It should be noted that, in the present embodiment, the luminance signal is a voltage signal.

[3] TFT Circuit 214

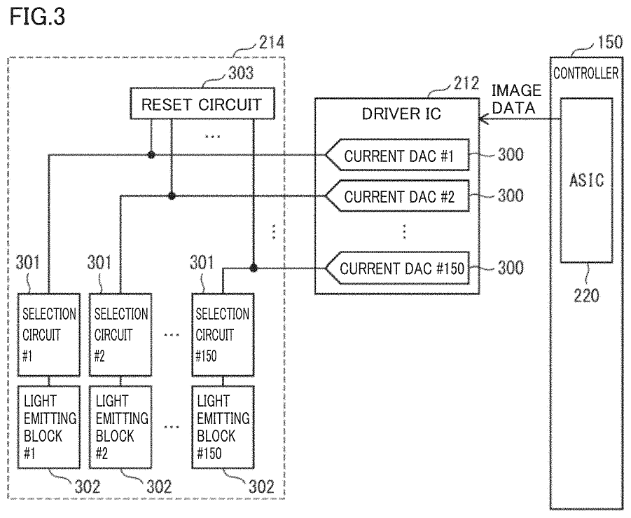

FIG. 3 is a view schematically showing a configuration of TFT circuit 214. Referring to FIG. 3, the configuration of TFT circuit 214 will be described.

As shown in FIG. 3, in TFT circuit 214, 15,000 light emitting element matrices 320 are grouped into 150 light emitting blocks 302 each including 100 light emitting element matrices 320. Although the present embodiment describes, as an example, a case where one light emitting element matrix 320 includes 100 light emitting elements and each light emitting element is an organic light emitting diode (OLED), each light emitting element may be a semiconductor light emitting diode (LED).

Driver IC 212 includes 150 current digital-to-analog converter (DAC) 300. Current DACs 300 are digitally controllable variable current sources, and correspond one-to-one to light emitting blocks 302. Light emitting blocks 302 are arranged in the main scanning direction. Microlenses constituting microlens array 201 correspond one-to-one to light emitting element matrices 320, and any emitted light from the light emitting elements included in one light emitting element matrix 320 is condensed on the outer circumferential surface of photoreceptor drum 101 by one microlens.

A selection circuit 301 is placed on each circuit extending from current DAC 300 toward light emitting block 302. Further, a reset circuit 303 is connected on circuits extending from driver IC 212 toward selection circuits 301. Each current DAC 300 sequentially outputs a luminance signal by so-called rolling driving to 100 light emitting element matrices 320 under control thereof. One current DAC 300 is time-shared by 100 light emitting element matrices 320 included in light emitting block 302 corresponding one-to-one to that current DAC 300.

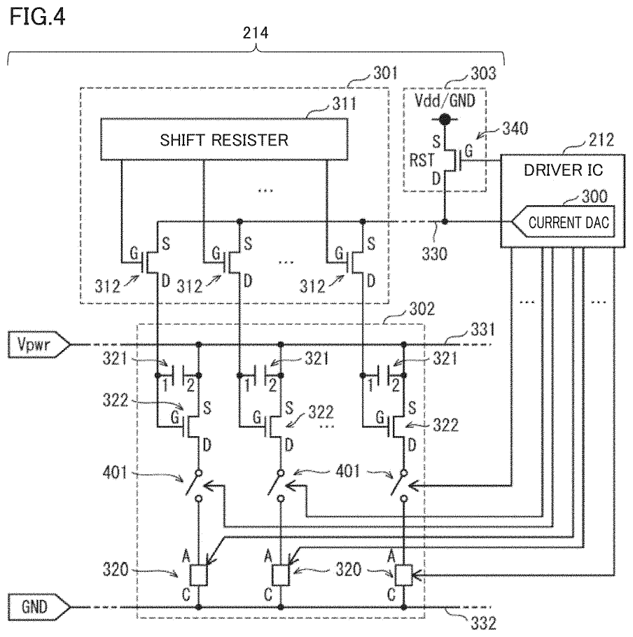

FIG. 4 is a view for illustrating a circuit configuration of TFT circuit 214. As shown in FIG. 4, in TFT circuit 214, light emitting block 302 includes 100 light emitting pixel circuits, and each light emitting pixel circuit has one capacitor 321, one drive TFT 322, and one light emitting element matrix 320. Further, selection circuit 301 includes a shift resister 311 and 100 selection TFTs 312, and reset circuit 303 includes a reset TFT 340.

Shift resister 311 is connected to gate terminals of 100 selection TFTs 312, and sequentially turns on selection TFTs 312 per main scanning period. Each selection TFT 312 has a source terminal connected to current DAC 300 through a writing wire 330, and a drain terminal connected to a first terminal of capacitor 321 and a gate terminal of drive TFT 322.

When shift resister 311 turns on selection TFT 312, an output current of current DAC 300 flows to the first terminal of capacitor 321, and a charge is accumulated in capacitor 321. The charge accumulated in capacitor 321 is held until it is reset by reset circuit 303.

The first terminal of capacitor 321 is also connected to the gate terminal of drive TFT 322, and a second terminal of capacitor 321 is connected to a source terminal of drive TFT 322 and a power supply wire 331. One terminal of a switch 401 is connected to a drain terminal of drive TFT 322, an anode-side terminal of light emitting element matrix 320 is connected to the other terminal of switch 401, and a cathode-side terminal of light emitting element matrix 320 is connected to a ground wire 332. Ground wire 332 is connected to a ground terminal GND, and power supply wire 331 is connected to a constant voltage source Vpwr.

Constant voltage source Vpwr serves as a supply source for a drive current to be supplied to each light emitting element matrix 320. A luminance signal (voltage signal) held between the first and second terminals of capacitor 321 is applied to drive TFT 322 as a gate-source voltage Vgs, and thereby drive TFT 322 supplies a drive current having a current amount in accordance with the luminance signal to light emitting element matrix 320.

For example, when a luminance signal corresponding to H is written in capacitor 321, drive TFT 322 is turned on, and light emitting element matrix 320 emits light. Further, when a luminance signal corresponding to L is written in capacitor 321, drive TFT 322 is turned off, and light emitting element matrix 320 does not emit light. The luminance signal written in capacitor 321 is held until a next luminance signal is written or reset TFT 340 is turned on.

When reset TFT 340 is turned on, a wire extending from current DAC 300 to capacitors 321 is reset to a reset potential. The reset potential may be a Vdd potential or a ground potential, and any appropriate potential may be selected. In addition, although the present embodiment describes a case where light emitting element matrices 320 do not emit light in a reset state, light emitting element matrices 320 may emit light in a reset state.

It should be noted that, although the present embodiment describes, as an example, a case where drive TFTs 322 are of a p-channel type, it is needless to say that n-channel type drive TFTs 322 may be used.

In addition, although the present embodiment describes a case where reset circuit 303 is provided separately from driver IC 212 and is placed under the control of driver IC 212, reset circuit 303 may be alternatively included in driver IC 212. In addition, the function of reset circuit 303 may be implemented by changing the polarity of the current output by the current DAC between resetting and writing. In addition, instead of reset TFT 340, a switching element other than a TFT may be used.

[4] Driver IC 212

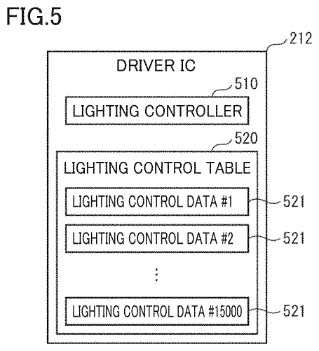

FIG. 5 is a view showing a configuration of driver IC 212. Referring to FIG. 5, the configuration of driver IC 212 will be described.

As shown in FIG. 5, driver IC 212 includes a lighting controller 510 and a lighting control table 520, and lighting control table 520 records lighting control data corresponding to each of 1,500,000 light emitting elements (constituting 15,000 light emitting element matrices 320). Lighting controller 510 refers to the lighting control data recorded in lighting control table 520 for each light emitting element matrix 320, and designates light emitting elements which should emit light.

[5] Light Emitting Element Matrix 320

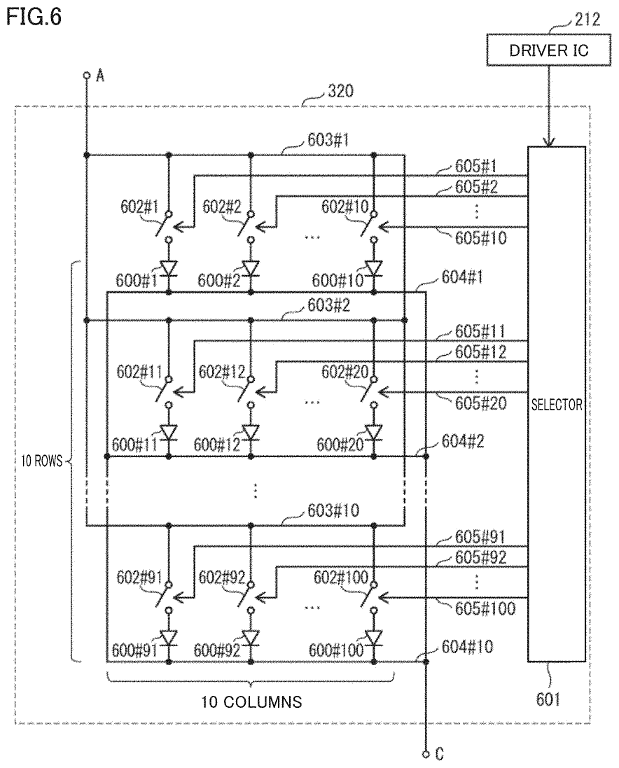

FIG. 6 is a view showing a configuration of light emitting element matrix 320. Referring to FIG. 6, light emitting element matrix 320 will be described.

As shown in FIG. 6, light emitting element matrix 320 includes 100 light emitting elements 600 arranged in 10 rows and 10 columns, and 100 switches 602. Each switch 602 switches between conduction and non-conduction for each light emitting element 600 under the control of a selector 601.

In light emitting element matrix 320, 10 anode wires 603 for the respective rows branch off from an anode terminal A, and one terminals of 10 switches 602 are connected to each anode wire 603. In addition, an end portion of each anode wire 603 opposite to anode terminal A is connected to an end portion of anode wire 603 for an adjacent row.

For each row, other terminals of 10 switches 602 are connected to anode terminals of light emitting elements 600, respectively. Cathode terminals of those light emitting elements 600 are connected to a cathode wire 604. Each switch 602 receives a control signal via a control wire 605, and switching on/off thereof is controlled by selector 601. Thereby, lighting of light emitting element 600 is controlled. When lighted, light emitting element 600 emits light with a light emission amount in accordance with the amount of a drive current supplied to anode terminal A.

In addition, lighting of entire light emitting element matrix 320 is controlled by driver IC 212 controlling switching on/off of switch 401 in accordance with image data (a video signal).

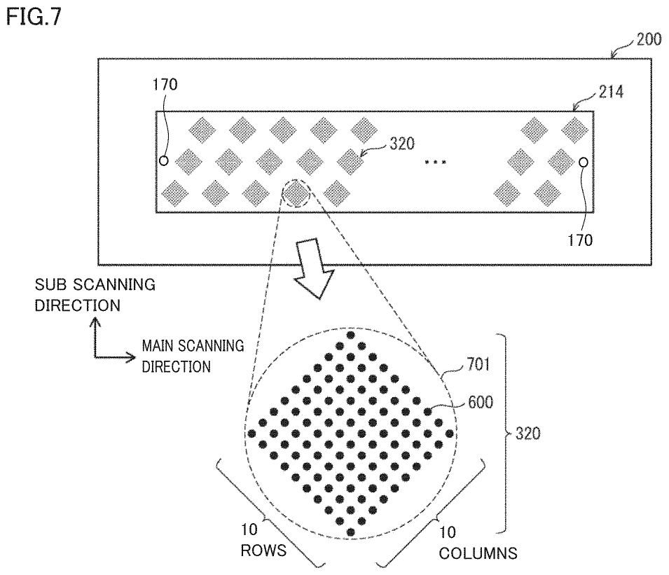

FIG. 7 is a view for illustrating arrangement of light emitting elements 600 in each light emitting element matrix 320 of TFT circuit 214. As shown in FIG. 7, light emitting element matrices 320 are staggered on TFT circuit 214. One hundred light emitting elements 600 constituting one light emitting element matrix 320 are arranged in the shape of a grid with 10 rows and 10 columns to fit within a circular region 701 having the same size as that of a microlens corresponding to that light emitting element matrix 320.

As with anode wires 603, cathode wires 604 are provided for the respective rows, and branch off from a cathode terminal C. An end portion of each cathode wire 604 opposite to cathode terminal C is connected to an end portion of cathode wire 604 for an adjacent row.

It should be noted that, instead of connecting cathode wires 604 to common cathode terminal C, cathode terminal C may be provided individually for each cathode wire 604. In addition, instead of connecting switches 602 to anode wire 603 and connecting light emitting elements 600 to cathode wire 604, light emitting elements 600 may be connected to anode wire 603 and switches 602 may be connected to cathode wire 604.

As shown in FIG. 7, a temperature sensor 170 is provided on TFT circuit 214 of light emitting substrate 200. In the example shown in FIG. 7, a plurality of temperature sensor elements are arranged along the main scanning direction. It should be noted that temperature sensor 170 is provided to detect an ambient temperature of a region in which light emitting elements 600 are arranged. The number and arrangement of the temperature sensor elements constituting temperature sensor 170 are not limited to those shown in FIG. 7.

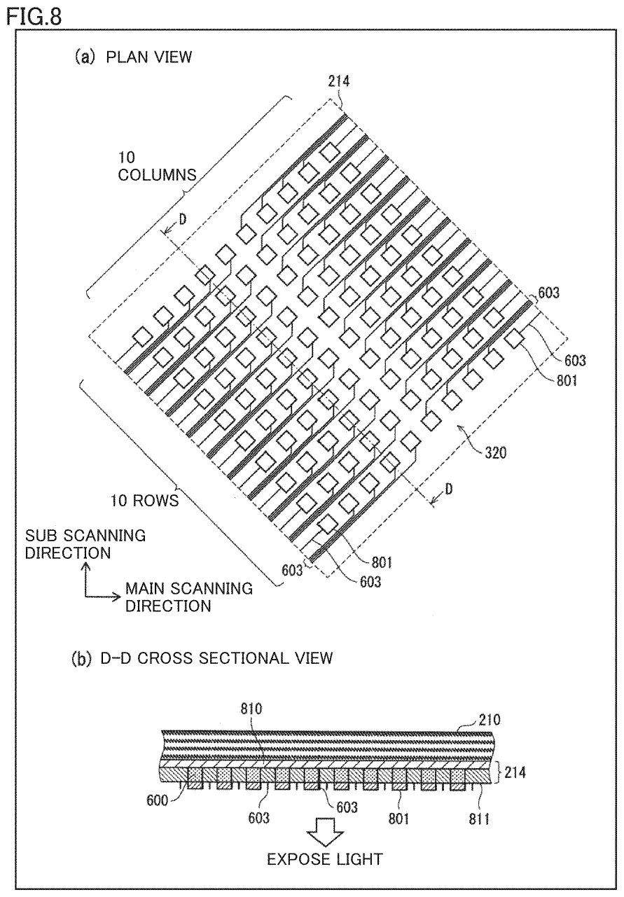

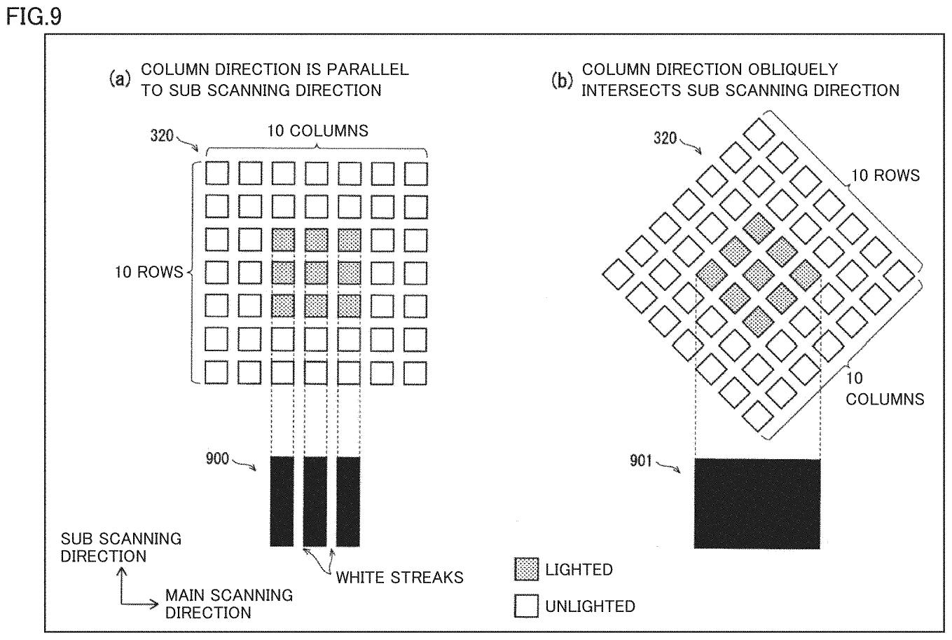

FIG. 8 is a view showing a wiring pattern of light emitting element matrix 320. FIG. 8(a) shows a plan view of the wiring pattern of light emitting element matrix 320, and FIG. 8(b) shows a cross sectional view of the wiring pattern of light emitting element matrix 320 taken along a line D-D. FIG. 9 is a view for illustrating the relation between the arrangement of the light emitting elements in light emitting element matrix 320 and an image formed utilizing light emitting element matrix 320. FIG. 9(a) shows white streaks that appear in the image when the column direction of light emitting element matrix 320 is parallel to a sub scanning direction. FIG. 9(b) shows the image formed when the column direction of light emitting element matrix 320 obliquely intersects the sub scanning direction.

1 As shown in FIG. 8(a), the wiring pattern of light emitting element matrix 320 is a pattern in which both the row direction and the column direction of light emitting elements 600 covered with anode electrodes 801 are inclined with respect to the main scanning direction in plan view. When the row direction is orthogonal to the sub scanning direction and the column direction is orthogonal to the main scanning direction, spacings between the rows or the columns of light emitting elements 600 may be visually recognized as white streaks in a formed image 900 (FIG. 9(a)). In contrast, when the row direction obliquely intersects the sub scanning direction and the column direction obliquely intersects the main scanning direction, white streaks can be reduced in a formed image 901 (FIG. 9(b)). Although the inclination angle is 45 degrees in the example of FIG. 8(a), the inclination angle may be other than 45 degrees.

As shown in FIG. 8(b), in the cross sectional view taken along line D-D in FIG. 8(a), TFT circuit 214 is formed on glass substrate 210. Of TFT circuit 214, anode wires 603 are light-shielding aluminum wires. On anode wires 603, an insulating film 811 and light emitting elements 600 are formed, and on light emitting elements 600, anode electrodes 801 are formed.

Anode electrodes 801 are made of a light-transmitting indium tin oxide (ITO) film, and emitted light from light emitting elements 600 penetrates through anode electrodes 801 toward microlens array 201. Each anode electrode 801 receives a drive current via anode wire 603.

[6] Microlens Array 201

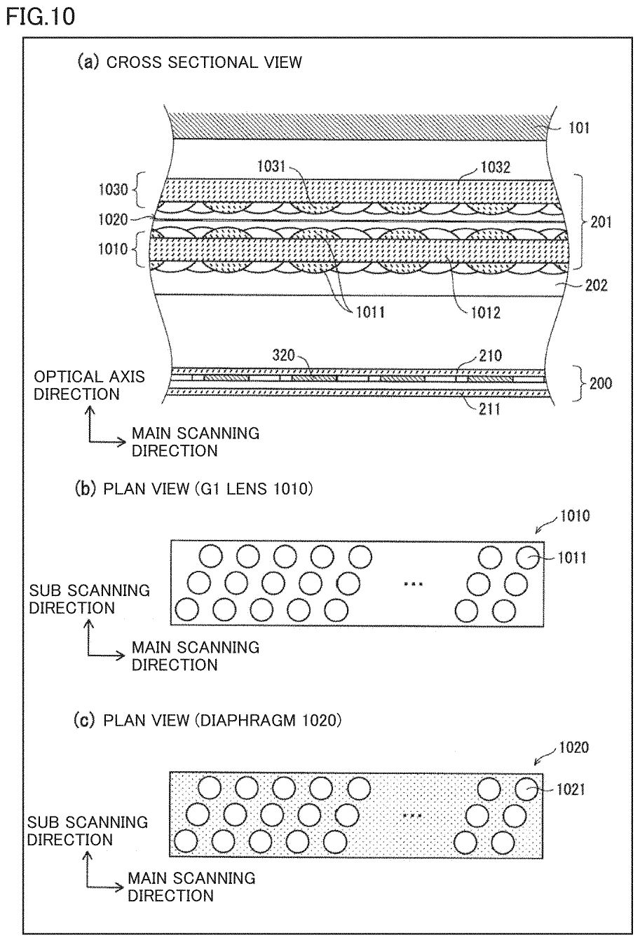

FIG. 10 is a view for illustrating a configuration of microlens array 201. FIG. 10(a) shows a cross sectional view of optical writing device 100, FIG. 10(b) shows a plan view of a G1 lens 1010, and FIG. 10(c) shows a plan view of a diaphragm 1020. Referring to FIG. 10, the configuration of microlens array 201 will be described.

In the present embodiment, microlens array 201 is made of a material having a linear expansion coefficient higher than that of holding member 202, and a difference in linear expansion occurs between microlens array 201 and holding member 202 when an environmental temperature rises or falls. Since microlens array 201 and holding member 202 are long in the main scanning direction, the difference in linear expansion also increases in particular in the main scanning direction.

In addition, when compared with microlens array 201, holding member 202 is thicker, has a higher rigidity, and is less likely to be deformed. Thus, microlens array 201 is more likely to be deformed than holding member 202 due to occurrence of the difference in linear expansion.

As shown in FIG. 2(a), the light emitting substrate 200 side of microlens array 201 is fixed to holding member 202, and thus thermal expansion is suppressed. In contrast, the photoreceptor drum 101 side of microlens array 201 is not fixed to the holding member, and thus thermal expansion is not suppressed. Accordingly, microlens array 201 becomes distorted to curve toward photoreceptor drum 101 due to thermal expansion.

As shown in FIG. 10(a), microlens array 201 is a so-called telecentric optical system, and G1 lens 1010, diaphragm 1020, and a G2 lens 1030 are placed in order from the one closer to light emitting substrate 200. G1 lens 1010 and G2 lens 1030 are transparent members made of a resin material or a glass material.

G1 lens 1010 includes planoconvex lenses attached to both main surfaces of a flat plate-like member 1012, and G2 lens 1030 includes planoconvex lenses attached to a main surface of a flat plate-like member 1032 on a side closer to light emitting substrate 200. Each planoconvex lens may be spherical or aspherical.

As shown in FIG. 10(b), in G1 lens 1010, 15,000 microlenses 1011 are staggered in 3 rows and 5,000 columns. Each microlens 1011 functions as a biconvex lens by combining two planoconvex lenses, and refracts emitted light from light emitting element matrix 320 located at an overlapping position when viewed from an optical axis direction.

Also in G2 lens 1030, as in G1 lens 1010, 15,000 microlenses 1031 are staggered in 3 rows and 5,000 columns, and each microlens 1031 refracts the emitted light from light emitting element matrix 320 located at the overlapping position when viewed from the optical axis direction. However, microlenses 1031 constituting G2 lens 1030 are each a planoconvex lens.

In G1 lens 1010, portions where microlenses 1011 are provided in the main scanning direction are thick, and portions where microlenses 1011 are not provided are relatively thin. Accordingly, the portions where microlenses 1011 are not provided have a lower rigidity and are more likely to be deformed than the portions where microlenses 1011 are provided.

Also in G2 lens 1030, as in G1 lens 1010, portions where microlenses 1031 are provided in the main scanning direction are thick, and portions where microlenses 1031 are not provided are relatively thin. Accordingly, the portions where microlenses 1031 are not provided have a lower rigidity and are more likely to be deformed than the portions where microlenses 1031 are provided.

As shown in FIG. 10(c), diaphragm 1020 is a flat plate-like member made of a light-shielding material such as resin or metal, and is provided with 15,000 through holes 1021 corresponding one-to-one to 15,000 microlenses 1011 and 15,000 microlenses 1031. After the emitted light from each light emitting element matrix 320 passes through microlens 1011 of G1 lens 1010, only a portion thereof entering through hole 1021 of diaphragm 1020 proceeds to microlens 1031 of G2 lens 1030, and the remaining portion is blocked.

Microlens array 201 and light emitting substrate 200 are covered with a cover not shown such that dust and the like may not block the emitted light from light emitting element matrices 320.

[7] Configuration of Controller 150

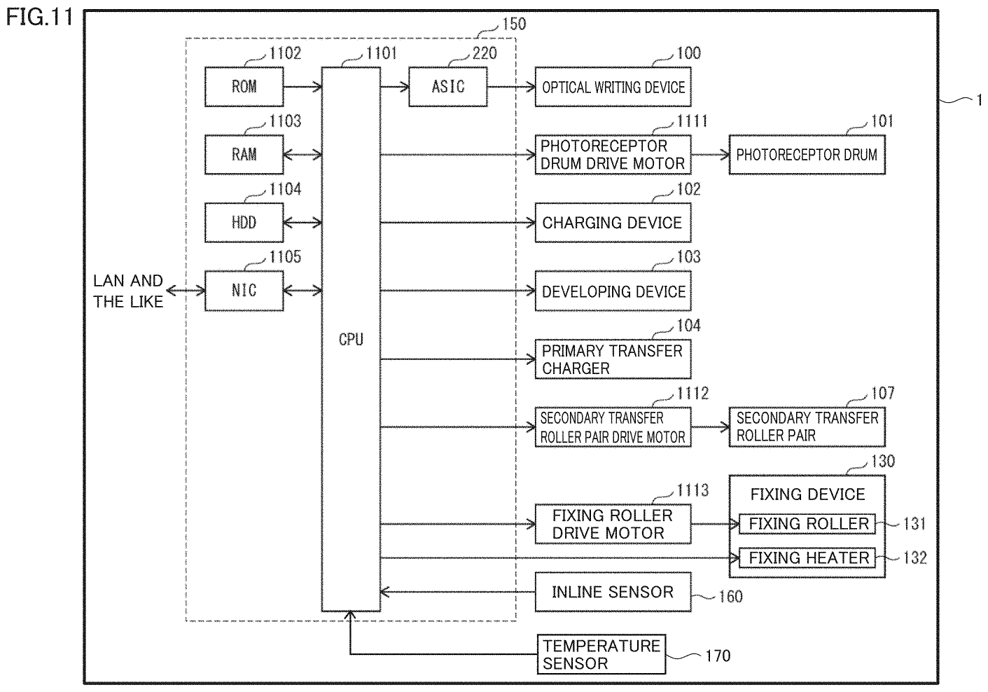

FIG. 11 is a view showing a hardware configuration of image formation apparatus 1.

Controller 150 includes a central processing unit (CPU) 1101, a read only memory (ROM) 1102, a random access memory (RAM) 1103, and the like. When image formation apparatus 1 is powered on, CPU 1101 reads a boot program from ROM 1102 and starts the program, and executes an operating system (OS) and a control program read from a hard disk drive (HDD) 1104, using RAM 1103 as a working storage region.

A network interface card (NIC) 1105 is used to communicate with an external apparatus such as a personal computer (PC), via a communication network such as Local Area Network (LAN). Upon receiving a print job from the external apparatus, controller 150 controls each device of image formation apparatus 1, and performs image formation processing in accordance with the print job.

In this case, controller 150 controls a photoreceptor drum drive motor 1111 to rotationally drive each photoreceptor drum 101, and also controls charging device 102 to uniformly charge the outer circumferential surface of each photoreceptor drum 101, controls optical writing device 100 to expose light, and controls developing device 103 to perform development. It should be noted that controller 150 includes ASIC 220, and controls operation of optical writing device 100) through ASIC 220.

Controller 150 can control a light emission amount for each light emitting element matrix 320, by designating the value of the luminance signal to be output by current DAC 300. The value of the luminance signal is also designated to optical writing device 100 through ASIC 220. Thus, controller 150 causes HDD 1104 to store the value of the luminance signal to be output by current DAC 300 for each light emitting element matrix 320.

Further, controller 150 controls a secondary transfer roller pair drive motor 1112 to rotationally drive secondary transfer roller pair 107, in accordance with the rotational driving of each photoreceptor drum 101. Thereby, intermediate transfer belt 106 rotationally travels. Controller 150 applies a primary transfer voltage to primary transfer charger 104, and electrostatically transfers a toner image from the outer circumferential surface of each photoreceptor drum 101 onto an outer circumferential surface of intermediate transfer belt 106.

Controller 150 controls a fixing roller drive motor 1113 to rotationally drive a fixing roller 131 of fixing device 130, and also increases the temperature of a fixing heater 132, and thereby thermally fixes a color toner image onto recording sheet S.

When inline sensor 160 detects the leading edge of recording sheet S, controller 150 reads the toner image thermally fixed on the recording sheet. Thereby, digital image data is generated and recorded in HDD 1104.

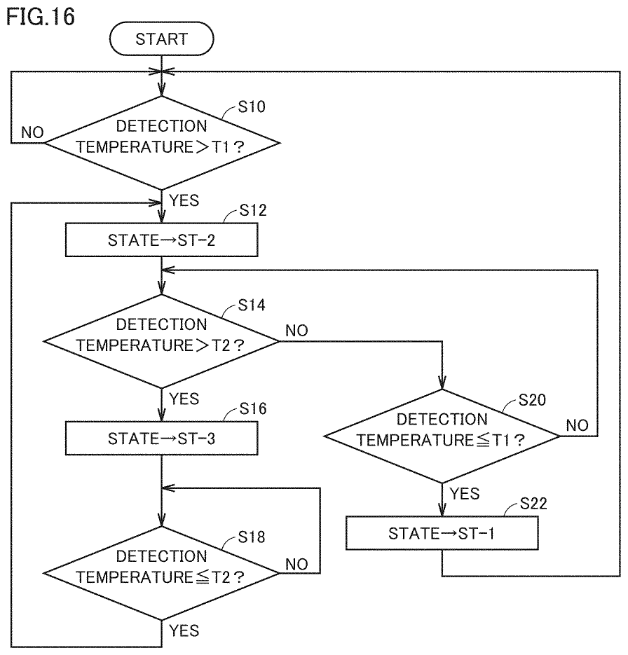

Controller 150 controls optical writing device 100 in accordance with the temperature detected by temperature sensor 170. The manner of the control will be described later with reference to FIG. 16 and the like.

[8] Control of Light Emitting Element Matrix 320 in Accordance with Ambient Temperature

(Shape of Beam on Photoreceptor Drum)

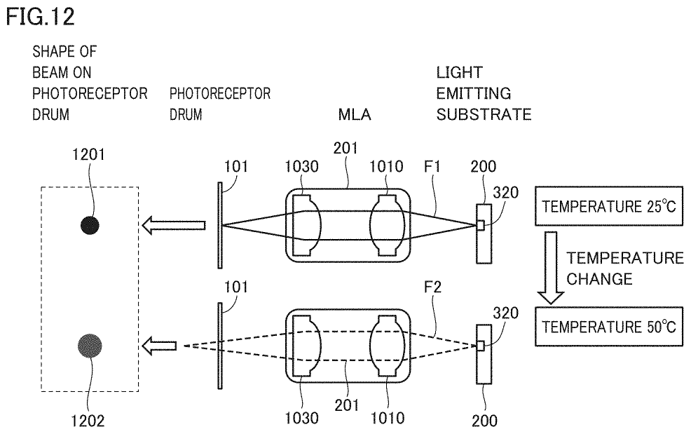

FIG. 12 is a view schematically showing an example of the relation between an environmental temperature of the light emitting elements and the shape of a beam formed on a photoreceptor drum. The upper portion of FIG. 12 shows light emitting element matrix 320 on light emitting substrate 200, microlens array 201 (G1 lens 1010 and G2 lens 1030), and photoreceptor drum 101 when the ambient temperature in the vicinity of the light emitting elements is 25° C. The lower portion of FIG. 12 shows the same components when the ambient temperature in the vicinity of the light emitting elements is 50° C. In FIG. 12, light fluxes F1 and F2 schematically represent light fluxes output from light emitting element matrix 320 at an ambient temperature of 25° C. and 50° C., respectively.

As shown in the upper portion of FIG. 12, in optical writing device 100, when the ambient temperature is 25° C., light output from light emitting element matrix 320 and passing through G1 lens 1010 and G2 lens 1030 is imaged on the surface of photoreceptor drum 101.

In contrast, in a case where the shapes of G1 lens 1010 and G2 lens 1030 are relatively significantly influenced by the temperature, when the ambient temperature rises, an imaging position may deviate from the surface of photoreceptor drum 101. For example, as shown in the lower portion of FIG. 12, when the ambient temperature rises to 50° C., the distance from light emitting element matrix 320 to a position where the light output therefrom is imaged may become longer than an imaging distance obtained when the ambient temperature is 25° C., due to expansion of at least one of G1 lens 1010 and G2 lens 1030. An example of such a case is a case where the material for at least one of G1 lens 1010 and G2 lens 1030 is resin (for example, polymethyl methacrylate resin).

Due to an increased imaging distance, the shape of an image of the light output from light emitting element matrix 320 formed on the surface of photoreceptor drum 101 changes. More specifically, an image 1202 obtained when the ambient temperature is 50° C. has a diameter larger than that of an image 1201 obtained when the ambient temperature is 25° C.

(Plurality of Lighted States of 100 Light Emitting Elements in Light Emitting Element Matrix)

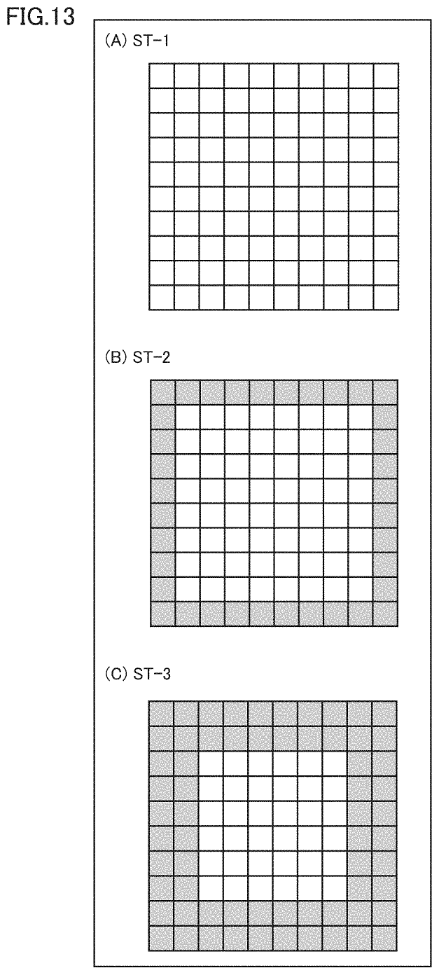

FIG. 13 is a view showing specific examples of a manner of ON/OFF of each of 100 light emitting elements 600 constituting light emitting element matrix 320. In each of FIG. 13(A), FIG. 13(B), and FIG. 13(C), 100 light emitting elements 600 arranged in a 10 by 10 matrix are represented as 10 by 10 squares. FIG. 13(A), FIG. 13(B), and FIG. 13(C) represent three states (ST-1, ST-2, and ST-3), respectively.

Each of the three states shown in FIG. 13 represents the relation between the gradation of a pixel corresponding to light emitting element matrix 320 and an actual manner of lighting ON/OFF of 100 light emitting elements 600 constituting that light emitting element matrix 320. A square filled in with white represents lighted light emitting element 600. A square filled in with gray represents unlighted light emitting element 600.

More specifically, in state ST-1, all of 100 light emitting elements 600 are lighted. In state ST-2, of 100 light emitting elements 600, 36 light emitting elements 600 arranged in the outermost row and column are unlighted, and 64 light emitting elements 600 arranged inside are lighted. In state ST-3, of 100 light emitting elements 600, 64 light emitting elements 600 arranged in outer two rows and two columns are unlighted, and 36 light emitting elements 600 arranged inside are lighted.

(Overview of Control in Accordance with Ambient Temperature)

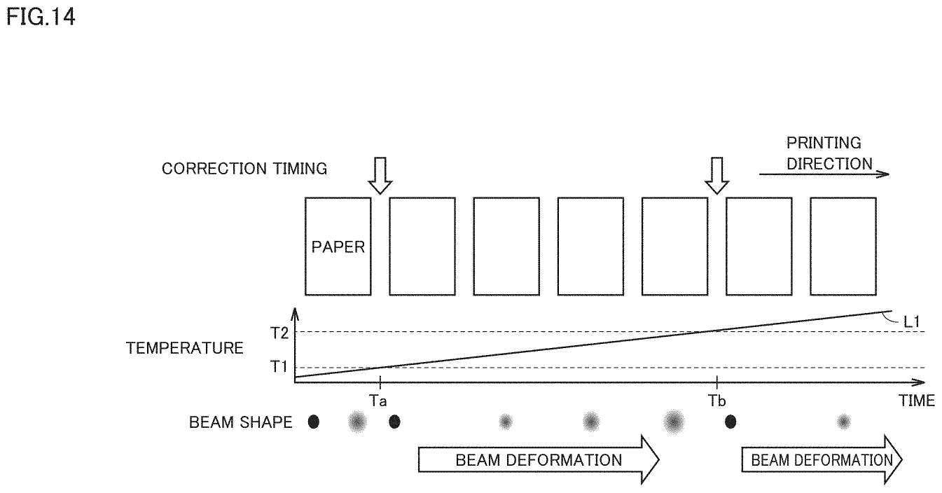

FIG. 14 is a view for illustrating an overview of control in accordance with the present embodiment.

In the middle of FIG. 14, a change in the temperature of light emitting substrate 200 as image formation is continued in image formation apparatus 1 is shown as a line L1. In a graph including line L1, the axis of abscissas represents time and the axis of ordinates represents temperature. As image formation is continued, the temperature of light emitting substrate 200 rises. The temperature of light emitting substrate 200 is detected by temperature sensor 170, for example. The detection temperature of temperature sensor 170 is an example of the ambient temperature of the region in which light emitting elements 600 are arranged.

Below the graph in FIG. 14, an image of the light (beam) output from light emitting element matrix 320 formed on the surface of photoreceptor drum 101 is schematically shown as a “beam shape”. At the left end of the graph in FIG. 14, the ambient temperature of light emitting elements 600 is sufficiently low, and thereby the beam shape is normal. However, as the ambient temperature rises, the distance required for imaging becomes longer, as described with reference to FIG. 12. Thereby, the image of the beam on the surface of photoreceptor drum 101 becomes larger.

In image formation apparatus 1, when the ambient temperature of light emitting elements 600 exceeds a first threshold value (a temperature T1 in FIG. 14), the area of a light outputting portion in light emitting element matrix 320 is narrowed. In an example, the state of light emitting element matrix 320 is changed from state ST-1 to state ST-2 in FIG. 13. In FIG. 14, a change in the area of the light outputting portion in light emitting element matrix 320 is indicated by an arrow as “correction timing”.

In the example of FIG. 14, the ambient temperature reaches temperature T1 at a time Ta, and accordingly, the state of light emitting element matrix 320 is changed from state ST-1 to state ST-2. Thereby, the image of the beam on the surface of photoreceptor drum 101 becomes smaller. Thereby, the size of the image of the beam returns to substantially the same size as that obtained when the ambient temperature is lower than temperature T1 (for example, when image formation apparatus 1 starts image formation).

However, when image formation is further continued, the ambient temperature of light emitting elements 600 further rises, and the image of the beam on the surface of photoreceptor drum 101 becomes larger again. In image formation apparatus 1, when the ambient temperature of light emitting elements 600 exceeds a second threshold value (a temperature T2 in FIG. 14), the area of the light outputting portion in light emitting element matrix 320 is further narrowed. In an example, the state of light emitting element matrix 320 is changed from state ST-2 to state ST-3 in FIG. 13.

In the example of FIG. 14, the ambient temperature of light emitting elements 600 rises from time Ta toward a time Tb, and the image of the beam on the surface of photoreceptor drum 101 gradually becomes larger. The ambient temperature reaches temperature T2 at time Tb, and accordingly, the state of light emitting element matrix 320 is changed from state ST-2 to state ST-3. Thereby, the image of the beam on the surface of photoreceptor drum 101 becomes smaller again. Thereby, the size of the image of the beam returns to substantially the same size as that obtained when the ambient temperature is lower than temperature T1 (for example, when image formation apparatus 1 starts image formation).

(Data for Control)

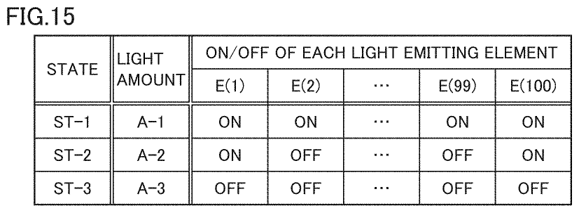

FIG. 15 is a view showing an example of data utilized to set optical writing device 100 to each of the three states (state ST-1 to state ST-3) shown in FIG. 13. FIG. 15 shows settings of a light amount and ON/OFF of each light emitting element 600, for each of the three states.

The “light amount” in FIG. 15 is a set value for a light amount per unit time of each light emitting element 600. A light amount A-1, a light amount A-2, and a light amount A-3 are set for state ST-1, state ST-2, and state ST-3, respectively.

In an example, the ratio between light amount A-1 and light amount A-2 is the inverse of the ratio between the number of light emitting elements 600 lighted in state ST-1 and the number of light emitting elements 600 lighted in state ST-2. That is, the ratio between the number of light emitting elements 600 lighted in state ST-1 and the number of light emitting elements 600 lighted in state ST-2 is 100:64. Therefore, the ratio between light amount A-1 and light amount A-2 is 64:100. Thereby, in light emitting element matrix 320, a decrease in the number of light emitting elements 600 to be lighted is compensated for by an increase in the light amount of each light emitting element 600. That is, a light amount as entire light emitting element matrix 320 is maintained.

In an example, the ratio between light amount A-1 and light amount A-3 is the inverse of the ratio between the number of light emitting elements 600 lighted in state ST-1 and the number of light emitting elements 600 lighted in state ST-3. That is, the ratio between the number of light emitting elements 600 lighted in state ST-1 and the number of light emitting elements 600 lighted in state ST-3 is 100:36. Therefore, the ratio between light amount A-1 and light amount A-3 is 36:100.

An example of controlling the light amount of each light emitting element 600 is implemented by controlling the value of a current to be supplied to each light emitting element 600. That is, an increase (decrease) in light amount can be implemented by an increase (decrease) in the value of the current to be supplied. Another example is implemented by a conduction time per unit time (for example, one second) to each light emitting element 600. That is, an increase (decrease) in light amount can be implemented by an increase (decrease) in the conduction time per unit time.

The “ON/OFF of each light emitting element” in FIG. 15 represents a lighted/unlighted state of each of 100 light emitting elements 600 constituting each light emitting element matrix 320. More specifically, the “ON/OFF of each light emitting element” is information utilized when light emitting element matrix 320 needs to be lighted for a corresponding pixel, to control the lighted/unlighted state of each of 100 light emitting elements 600 constituting that light emitting element matrix 320, in accordance with the ambient temperature as described with reference to FIG. 13. The “ON/OFF of each light emitting element” defines lighting/unlighting (ON/OFF) of each of 100 light emitting elements 600 for each of the three states (state ST-1, state ST-2, state ST-3).

(Flow of Processing)

FIG. 16 is a flowchart of processing for controlling the lighted state of light emitting elements 600 of light emitting element matrix 320 in accordance with the ambient temperature. The processing of FIG. 16 is implemented, for example, by CPU 1101 of controller 150 executing a given program. The lighted state of light emitting elements 600 is controlled by driver IC 212 changing the state of conduction to light emitting elements 600 in accordance with an instruction from CPU 1101. In one embodiment, controller 150 reads the detection temperature of temperature sensor 170 sequentially (for example, per given time), and utilizes it for the processing of FIG. 16. The detection temperature of temperature sensor 170 is an example of the ambient temperature of light emitting elements 600. In the processing of FIG. 16, the lighted state of 100 light emitting elements 600 constituting light emitting element matrix 320 (hereinafter referred to as a “lighted state of light emitting element matrix 320”) is controlled in accordance with a change in ambient temperature. In one embodiment, the lighted state in an initial state is state ST-1.

Referring to FIG. 16, in step S10, CPU 1101 determines whether or not the detection temperature of temperature sensor 170 (hereinafter simply referred to as a “detection temperature”) exceeds first threshold value T1. When CPU 1101 determines that the detection temperature exceeds first threshold value T1 (YES in step S10), CPU 1101 advances the control to step S12, and otherwise (NO in step S10), CPU 1101 keeps the control in step S10.

In step S12, CPU 1101 controls the lighted state of light emitting element matrix 320 to state ST-2. More specifically, CPU 1101 controls ON/OFF of 100 light emitting elements 600 of each light emitting element matrix 320, in accordance with the “ON/OFF of each light emitting element” for state ST-2 in FIG. 15. Thereby, ON/OFF states of 100 light emitting elements 600 of each light emitting element matrix 320 are controlled to be shown as state ST-2 shown in FIG. 13(B).

In step S14, CPU 1101 determines whether or not the detection temperature exceeds second threshold value T2. When CPU 1101 determines that the detection temperature exceeds second threshold value T2 (YES in step S14), CPU 1101 advances the control to step S16, and otherwise (NO in step S14), CPU 1101 advances the control to step S20.

In step S16, CPU 1101 controls the lighted state of light emitting element matrix 320 to state ST-3.

In step S18, CPU 1101 determines whether or not the detection temperature is less than or equal to second threshold value T2. When CPU 1101 determines that the detection temperature is less than or equal to second threshold value T2 (YES in step S18), CPU 1101 returns the control to step S12, and otherwise (NO in step S18), CPU 1101 keeps the control in step S18.

In step S20, CPU 1101 determines whether or not the detection temperature is less than or equal to first threshold value T1. When CPU 1101 determines that the detection temperature is less than or equal to first threshold value T1 (YES in step S20), CPU 1101 advances the control to step S22, and otherwise (NO in step S20), CPU 1101 returns the control to step S14.

In step S22, CPU 1101 controls the lighted state of light emitting element matrix 320 to state ST-1. Then, CPU 1101 returns the control to step S10.

According to the processing of FIG. 16 described above, the lighted state of 100 light emitting elements 600 constituting light emitting element matrix 320 is controlled in accordance with the ambient temperature of light emitting elements 600. More specifically, light emitting element matrix 320 includes 100 light emitting elements 600 arranged in a 10 by 10 matrix. For light emitting element matrix 320 corresponding to a “lighted” pixel, three states, that is, state ST-1, state ST-2, and state ST-3 (FIG. 13) are defined. The initial state is state ST-1. When the ambient temperature of light emitting elements 600 exceeds threshold value T1, the state of light emitting element matrix 320 is controlled to state ST-2. When the ambient temperature of light emitting elements 600 exceeds threshold value T2, the state of light emitting element matrix 320 is controlled to state ST-3.

The above control can also be performed during printing in image formation apparatus 1. Thereby, sequential control of the lighted state of light emitting element matrix 320 in accordance with the temperature can be implemented.

CPU 1101 may adjust the light amount of each light emitting element 600 in accordance with the “light amount” for each state shown in FIG. 15, together with controlling the lighted state.

CPU 1101 utilizes the detection temperature of temperature sensor 170 in the processing of FIG. 16. When a plurality of temperature sensor elements are provided as temperature sensor 170 as shown in FIG. 7, a value derived by combining detection temperatures of the plurality of temperature sensor elements can be utilized in the processing of FIG. 16. For example, an average value of respectively detected temperatures is utilized.

[9] Adjustment for Each Image Formation Apparatus

The relation between the threshold value temperatures and the states to be controlled which are utilized in the processing of FIG. 16 may be set uniformly, or may be set for each image formation apparatus. More specifically, data for adjustment may be generated during manufacturing for each image formation apparatus, and the lighted state of each light emitting element matrix 320 may be controlled utilizing the data.

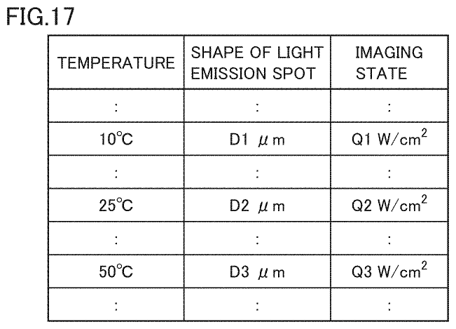

FIG. 17 is a view schematically showing an example of a database for adjustment generated during manufacturing. The database for adjustment is stored in HDD 1104, for example. The database for adjustment of FIG. 17 shows “temperature”, “shape of a light emission spot”, and “imaging state”. The “temperature” represents the ambient temperature of light emitting elements 600. The “shape of a light emission spot” represents the radius of an image on the surface of photoreceptor drum 101. The “imaging state” represents a light amount per unit area of the image on the surface of photoreceptor drum 101.

Controller 150 may control the lighted state of light emitting element matrix 320 with reference to the database for adjustment.

In one embodiment, controller 150 detects the ambient temperature of light emitting elements 600 per given time, obtains the shape of a light emission spot corresponding to that temperature in the database for adjustment, and determines the number of light emitting elements 600 to be lighted, among 100 light emitting elements 600 constituting light emitting element matrix 320, based on the obtained shape of the light emission spot.

More specifically, it is assumed that the ambient temperature of light emitting elements 600 is 50° C. Controller 150 obtains the shape of a light emission spot (the radius of an image) corresponding to 50° C. and the shape of a light emission spot (the radius of an image) corresponding to a reference temperature (for example, 25° C.) from the database for adjustment, and calculates the ratio therebetween. For example, when the ratio of the radius corresponding to 50° C. to the radius corresponding to 25° C. is 125%, controller 150 adjusts the lighted state of light emitting element matrix 320 (the number (and arrangement) of light emitting elements 600 to be lighted) such that the radius of the image corresponding to 50° C. becomes equal to 80% ({100/125}×100%) of the radius of the image corresponding to the reference temperature.

In one embodiment, controller 150 detects the ambient temperature of light emitting elements 600 per given time, obtains the imaging state corresponding to that temperature in the database for adjustment, and determines the light amount of each light emitting element 600 based on the obtained imaging state.

More specifically, it is assumed that the ambient temperature of light emitting elements 600 is 50° C. Controller 150 obtains the imaging state (the light amount per unit area) corresponding to 50° C. and the imaging state (the light amount per unit area) corresponding to a reference temperature (for example, 25° C.) from the database for adjustment, and calculates the ratio therebetween. For example, when the ratio of the light amount corresponding to 50° C. to the light amount corresponding to 25° C. is 80%, controller 150 adjusts the lighted state of light emitting element matrix 320 such that the light amount of each light emitting element 600 corresponding to 50° C. becomes equal to 125% (({100/80}×100%) of the light amount corresponding to the reference temperature.

The types of data stored in the database for adjustment are not limited to those shown in FIG. 17. More specifically, the radius of an image is a mere example of the “shape of a light emission spot”. Another example may be any value that follows a change in imaging position caused by a change in the shape of G1 lens 1010 and/or G2 lens 1030 due to the ambient temperature, such as a beam waist position (the distance from light emitting elements 600 to an imaging position), or a light amount per unit area of the image on the surface of photoreceptor drum 101.

In addition, the light amount per unit area of the image on the surface of photoreceptor drum 101 is a mere example of the “imaging state”. Another example may be any value that follows a change in imaging position caused by a change in the shape of G1 lens 1010 and/or G2 lens 1030 due to the ambient temperature, such as the beam waist position or the radius of the image on the surface of photoreceptor drum 101.

The database for adjustment may store only one information of the “shape of a light emission spot” and the “imaging state”. When the ambient temperature changes, controller 150 may control which light emitting elements 600 should be lighted among 100 light emitting elements 600 constituting light emitting element matrix 320, and the light amount of each light emitting element 600, based on that information. The “shape of a light emission spot” and the “imaging state” are each an example of information indicating a manner of imaging of light emitting element matrix 320 (the plurality of light emitting elements 600).

[10] Control of Light Emitting Element Matrices 320 in Accordance with Distances from Photoreceptor Drum 101

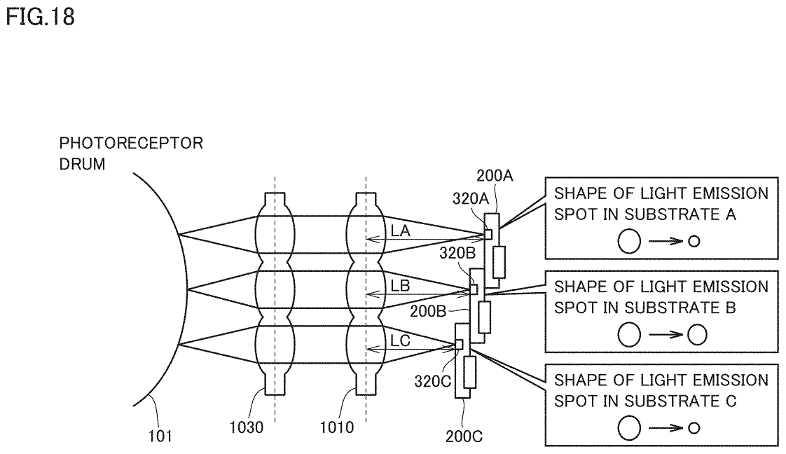

FIG. 18 is a view schematically showing a configuration of image formation apparatus 1 in which a plurality of light emitting element matrices 320 are respectively arranged at mutually different distances from the surface of photoreceptor drum 101.

In image formation apparatus 1, light emitting element matrices 320A, 320B, and 320C are arranged in light emitting substrates 200A, 200B, and 200C, respectively. According to the configuration in FIG. 18, the numbers of control circuits and wires required to be mounted in one light emitting substrate are reduced. Further, according to the configuration in FIG. 18, image formation apparatus 1 (optical writing device 100) can be downsized by arranging a plurality of light emitting substrates to be overlapped with each other in a deviated manner.

In FIG. 18, distances from light emitting element matrices 320A, 320B, and 320C to G1 lens 1010 are indicated as distances LA, LB, and LC, respectively, and these distances are mutually different. In the configuration of FIG. 18, distances from light emitting element matrices 320A, 320B, and 320C to the surface of photoreceptor drum 101 are mutually different.

When image formation apparatus 1 has a configuration as shown in FIG. 18, controller 150 preferably performs control of a light emitting state for each light emitting element matrix. Thereby, even when the ambient temperature of the light emitting elements changes, a change in the shape of an image formed from each of light emitting element matrices 320A, 320B, and 320C onto the surface of photoreceptor drum 101 can be suppressed more reliably.

Although embodiments of the present invention have been described and illustrated in detail, the disclosed embodiments are made for purposes of illustration and example only and not limitation. The scope of the present invention should be interpreted by terms of the appended claims.

What is claimed is:

1. An optical writing device comprising:
a lens;
a plurality of light emitting elements that form one pixel on a photoreceptor through the lens; and
a control circuit that controls a light emitting state of each of the plurality of light emitting elements in accordance with an ambient temperature of the plurality of light emitting elements.

2. The optical writing device according to claim 1, wherein the light emitting state of each of the plurality of light emitting elements includes a lighted/unlighted state and a light amount.

3. The optical writing device according to claim 1, wherein the control circuit controls the light emitting state of each of the plurality of light emitting elements in accordance with a result of comparison between the ambient temperature of the plurality of light emitting elements and a predetermined threshold value.

4. An image formation apparatus comprising:
the optical writing device according to claim 1;
the photoreceptor;
a temperature sensor that detects the ambient temperature of the plurality of light emitting elements; and
a control device that instructs the control circuit to control the light emitting state of each of the plurality of light emitting elements.

5. The image formation apparatus according to claim 4, comprising a storage device, wherein
the control device causes the storage device to store ambient temperatures of the plurality of light emitting elements and information indicating a manner of imaging on the photoreceptor by the plurality of light emitting elements, as a database for adjustment, and generates information for instructing control of the light emitting state of each of the plurality of light emitting elements, based on the information stored in the database for adjustment and the ambient temperature detected by the temperature sensor.

6. The image formation apparatus according to claim 4, wherein
the temperature sensor includes a plurality of temperature sensor elements arranged at mutually different positions in a main scanning direction of the photoreceptor, and
the control device utilizes a value derived by combining values respectively detected by the plurality of temperature sensor elements, as the ambient temperature of the plurality of light emitting elements.

7. The image formation apparatus according to claim 4, wherein
the plurality of light emitting elements are divided into a plurality of groups, the plurality of groups having mutually different distances from a surface of the photoreceptor, and
the control device instructs the control circuit to control the light emitting state of each of the plurality of light emitting elements for each of the plurality of groups.

8. A computer-implemented method comprising:
detecting an ambient temperature of a plurality of light emitting elements that form through a lens one pixel on a photoreceptor of an image formation apparatus; and
controlling a light emitting state of each of the plurality of light emitting elements in accordance with the ambient temperature of the plurality of light emitting elements.

9. The method according to claim 8, wherein the light emitting state of each of the plurality of light emitting elements includes a lighted/unlighted state and a light amount.

10. The method according to claim 8, wherein controlling the light emitting state of each of the plurality of light emitting elements is performed in accordance with a result of comparison between the ambient temperature of the plurality of light emitting elements and a predetermined threshold value.

11. The method according to claim 8, further comprising:
acquiring information, which corresponds to the detected ambient temperature, indicating a manner of imaging on the photoreceptor, by referring to a database storing ambient temperatures of the plurality of light emitting elements and the information indicating the manner of imaging on the photoreceptor; and
generating information for instructing control of the light emitting state of each of the plurality of light emitting elements based on the acquired information.

12. The method according to claim 8, wherein
the detecting the ambient temperature uses a plurality of temperature sensor elements arranged at mutually different positions in a main scanning direction of the photoreceptor, and
the controlling the light emitting state of each of the plurality of light emitting elements includes utilizing a value derived by combining values respectively detected by the plurality of temperature sensor elements, as the ambient temperature of the plurality of light emitting elements.

13. The method according to claim 8, wherein
the plurality of light emitting elements are divided into a plurality of groups, the plurality of groups having mutually different distances from a surface of the photoreceptor, and
the controlling the light emitting state of each of the plurality of light emitting elements includes controlling the light emitting state of each of the plurality of light emitting elements for each of the plurality of groups.
